(19) United States
(12) Patent Application Publication
(10) Pub. No.: US 2010/0191047 A1
(43) Pub. Date: Jul. 29, 2010

(54) ACTIVITY SIMULATOR

(76) Inventor: Alfred Xueliang Xin, Cincinnati, OH (US)

Correspondence Address: Alfred Xueliang Xin, 6310 Copperleaf Lane, Cincinnati, OH, 45230, US

(21) Appl. No.: 12/424,577

(22) Filed: Apr. 16, 2009

Related U.S. Application Data
(60) Provisional application No. 61/148,050, filed on Jan. 28, 2009.

(51) Int. Cl. A61H 19/00

(52) U.S. Cl. 600/38

(57) ABSTRACT

The invented simulator includes a housing and within which a reciprocator driven by a motor or magnetic or other driving forces disposed in the housing, that generates linear reciprocating movements. An arm connected to the reciprocator via a rock arm and further the arm may be covered with materials in penis shape that simulates male sexual intercourse behaviors and further as optional features the apparatus may be configured with functions that control reciprocating distances and speed, and still further it may simulate penis natural reaction immediately before and during ejaculation stage by injecting fluid or air into penis within designed areas as to enlarge the areas of penis. Various materials may be used to create finishes resembling human flash and the shapes of male sexual organ; the simulator may consists of components of male sexual organ, including penis, testicles and other features, or with any preferred shape, finishes and materials applied to its core functions. And still further the said simulator may be installed on a stern base as to enable the users of the said simulator to be hands-free as they are engaged in activities with the said simulator.

### BACKGROUND OF THE INVENTION

The present invention relates to female sexuality and more particularly the invented apparatus enables female to reach more satisfactions as naturally desired when perform masturbation.

The use of devices to assist masturbation is known in the prior art. More specifically, these inventions are concentrated on devices with vibrations, rotating or genital shapes and other means to assist female masturbation.

Known prior art dental cleaning devices disclosed in the U.S. Pat. Nos. 4,776,347, 5,072,720, 5,131,906, 5,256,123, 5,573,499, 5,674,238, 5,690,603, 5,690,605, 5,704,894, 5,724,994, 5,885,205, 6,165,108, 6,179,795, 7,104,950.

While these devices fulfill their respective, particular objectives and requirements, the aforementioned patents do not disclose a device that is attempted to imitate natural human motions as of male sexual-intercourse behaviors. The new invention possesses means that simulates male sexual-intercourse natural behaviors and therefore enables users to reach more satisfactions as humanly desired when perform masturbation.

### SUMMARY OF THE INVENTION

In accordance with the present invention, a male sexual intercourse simulator includes a housing, a drive mechanism disposed within the housing, a reciprocator coupled to the drive mechanism, a rocker arm coupled to the reciprocator, a functional arm connected with the said rocker arm and located within a restraining chamber, that creates linear back and forward reciprocating movements. The said housing and the said functional arm may be covered with male genital features, including but not limited to penis, testicles, and or any other shapes that may cover the said housing and the said functional arm.

In accordance with an alternate function of present invention, a male sexual intercourse simulator includes a housing, a drive mechanism disposed within the housing, a reciprocator coupled to the drive mechanism, a rocker arm coupled to the reciprocator, a functional arm connected with the said rocker arm and located within a restraining chamber, that creates linear back and forward reciprocating movements. The said housing and the said functional arm may be covered with male genital features, including but not limited to penis, testicles, and or any other shapes that may cover the said housing and the said functional arm. An resistor switch connected between the power and motor, that may offer speed changes of the said reciprocator, or any other means that may change the speed of the reciprocator.

In accordance with an alternate function of the present invention, a male sexual intercourse simulator includes a housing, a drive mechanism disposed within the housing, a reciprocator coupled to the drive mechanism, a rocker arm coupled to the reciprocator, a functional arm connected with the said rocker arm and located within a restraining chamber, that creates linear back and forward reciprocating movements. The said housing and the said functional arm may be covered with male genital features, including but not limited to penis, testicles, and or any other shapes that may cover the said housing and the said functional arm. The reciprocating distances may be varied by a control mechanism.

In accordance with an alternate function of present invention, a male sexual intercourse simulator includes a housing, a drive mechanism disposed within the housing, a reciprocator coupled to the drive mechanism, a rocker arm coupled to the reciprocator, a functional arm connected with the said rocker arm and located within a restraining chamber, that creates linear back and forward reciprocating movements. The said housing and the said functional arm may be covered with male genital features, including but not limited to penis, testicles, and or any other shapes that may cover the said housing and the said functional arm. The said simulator may be installed on a stern base as to enable the users of the said simulators to be hands-free as they are engaged in activities with the said simulators.

In accordance with an alternate function of present invention, a male sexual intercourse simulator includes a housing, a drive mechanism disposed within the housing, a reciprocator coupled to the drive mechanism, a rocker arm coupled to the reciprocator, a functional arm connected with the said rocker arm and located within a restraining chamber, that creates linear back and forward reciprocating movements, and male sexual organ made of materials resembling human flash and features of the said organ that covers the said housing and the said functional arm, or any other shapes of covers that covers the said housing and the said functional arm, and a fluid pump or air pump may be initiated by a switch, and ejecting fluid, air or other materials into the designed areas functional arm, and enlarge the said area: may penis or other shapes of coverage covering the said functional arm; the fluid may be heated up close to human body temperature before ejected into the functional area.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. In this respect, before explaining at least a few embodiments of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor it is intended to be limiting as to the scope of the invention in any way.

These and other features, aspects and advantages of the present invention will become better understood with reference to the following drawings, description and claims.

### BRIEF DESCRIPTION OF THE DRAWINGS

With reference now to the drawings, and in particular to FIGS. 1 through 12 thereof, sexual simulators embodying the principles and concepts of the present invention will be described.

FIG. 1 is an view of a male sexual intercourse simulator in accordance with an embodiment of the invention;

FIG. 2 is an view of a male sexual intercourse simulator in accordance with another embodiment of the invention;

FIG. 3 is a side elevation view, partly in section, of the male sexual intercourse simulator of FIG. 1 showing a drive mechanism in accordance with the invention;

FIG. 4 is a fragmental perspective view of the male sexual intercourse simulator of FIG. 1 in accordance with its mechanical structural positions;

FIG. 5 is a side elevation view, partly in section, of the male sexual intercourse simulator of FIG. 2 showing a drive mechanism in accordance with the invention;

FIG. 6 is a fragmental perspective view of the male sexual intercourse simulator of FIG. 2 in accordance with its mechanical structural positions;

FIG. 7 is a fragmental and structural perspective view of a fluid pumping and heating systems that are configured to the male sexual intercourse simulator illustrated in FIG. 2.

FIG. 8 is another fragmental and structural perspective view of a fluid pumping and heating systems that are configured to the male sexual intercourse simulator illustrated in FIG. 2.

FIG. 9 is a side view of the male sexual intercourse simulator shown switch and blocking button of the pump system without featured coverings.

FIG. 10 is a top view of the male sexual intercourse simulator shown switch and blocking panel of the pump system without featured coverings.

FIG. 11, is a top view of a sexual intercourse simulator in FIG. 1, or FIG. 2 may be installed or attached to a base 300 such as a stern pad, by a means of installation or attachment,

FIG. 12, a flowchart illustrates wiring and functional relations of an embodiment integrated with pump and heating systems.

### DETAILED DESCRIPTION OF THE INVENTION

The following detailed description is of the best currently contemplated modes of carrying out the present invention. The description is not to be taken in a limiting sense, but is made merely for the purpose of illustrating the general principles of the invention, since the scope of the invention is best defined by the appended claims.

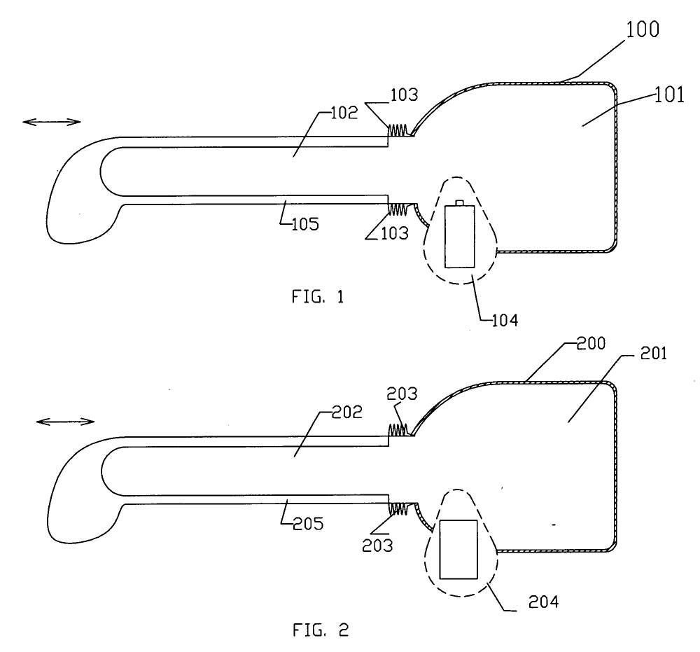

Referring now to the drawings in detail, and particularly FIG. 1, a preferred embodiment of a male sexual intercourse simulator generally designated 100 is shown including a housing 101 for housing a drive mechanism, and functional arm 102 driven by the said drive mechanism which generates linear reciprocating motions. The said housing and the said functional arm may be covered with selected materials in the shape of male genital and also resembling human flash and features of the said organ, including but not limited to penis 105, testicles 104 and other features and structures, or in any other preferred shapes and designs. A portion of the covering materials 103 that covers functional arm in adjacent to the housing may be made in flexible and expandable form as to allow the functional arm freely reciprocating within a range.

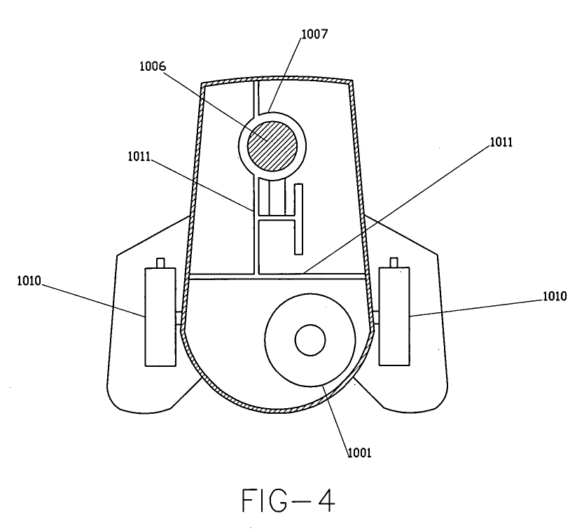

With reference to FIGS. 3 and 4, the said driven mechanism includes a motor 1001 may be powered by a battery (ies) 1010 or any other energy resource coupled to the motor 1001 through a switch (not shown), and a gearbox generally designated 1002 is installed on the supporting structures 1011, or any other forms of mechanism that generates linear reciprocating motions, is driven by the said motor. A functional arm 1006 that is bearingly attached to a rocker arm 1005 and 1004, and is housed by restraining tube 1007, which regulates horizontal reciprocating motion.

Still With reference to FIG. 3 and FIG. 4 to illustrate the structure of the power train and linear reciprocating motions, the motor 1001 is shown including a motor drive shaft 1604 for coupling the motor 1001 to a first bevel pinion gear 1606. drive shaft 1604 extends through wall 1011 through an aperture 1607. The first bevel pinion gear 1606 is coupled to a first driven bevel gear 1610 which in turn is coupled to a first spur gear 1612, a number of driven and spur gears installed on gear box supporting structure 1011 may be engaged in one after another as needed in order to reduce rotating speed and increase torque. A driven gear 1630 as last gear in the chain of gears is shown with a pin 1651 eccentrically installed. Pin 1651 is engageable to a reciprocator generally designated 1004, 1005, 1006, 1007 which will be described in further detail hereafter.

With continued reference to FIGS. 3 and 4, a rocker arm 1004 is shown bearingly connected one-end with the pin 1651 and the other end is bearingly connected with the functional arm 1006. The functional arm 1006 that is bearingly attached to a rocker arm 1005 and 1004 is housed by restraining tube 1007, which regulates horizontal reciprocating motion.

With reference to FIG. 1, functional arm 1006 (FIG. 3) is now covered with materials in the shape of penis 105; housing 1000 (FIG. 3) is now covered with materials in other structures of male genital 101; and the batteries compartments 1010 (FIG. 3, 4) are now covered with materials in the shape of testicles 104.

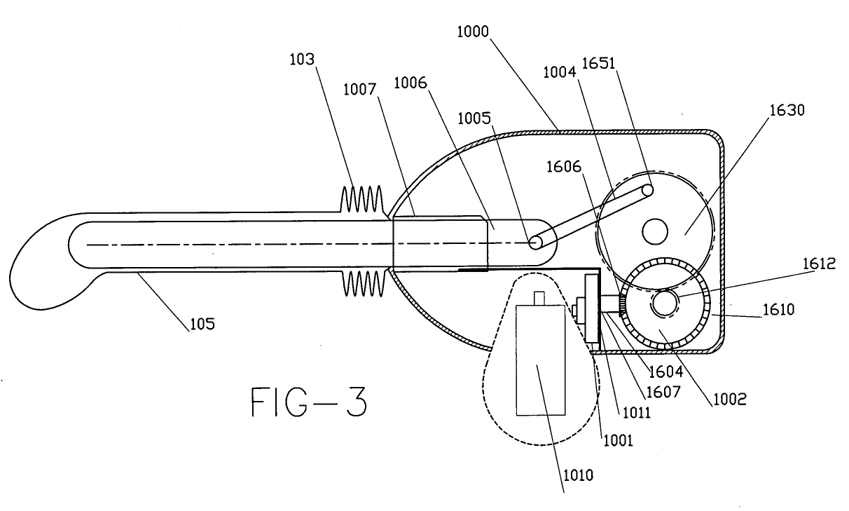

Referring now to the drawings in detail, and particularly FIG. 2, another preferred embodiment of a male sexual intercourse simulator generally designated 200 is shown including a housing 201 for housing a drive mechanism, and functional arm 202 driven by the said drive mechanism which generates linear reciprocating motions. The said housing and the said functional arm may be covered with selected materials in the shape of male genital and also resembling human flash and features of the said organ, including but not limited to penis 205, testicles 204 and other features and structures, or in any other preferred shapes and designs. A portion of the covering materials 203 that covers functional arm in adjacent to the housing may be made in flexible and expandable form as to allow the functional arm freely reciprocating within a range.

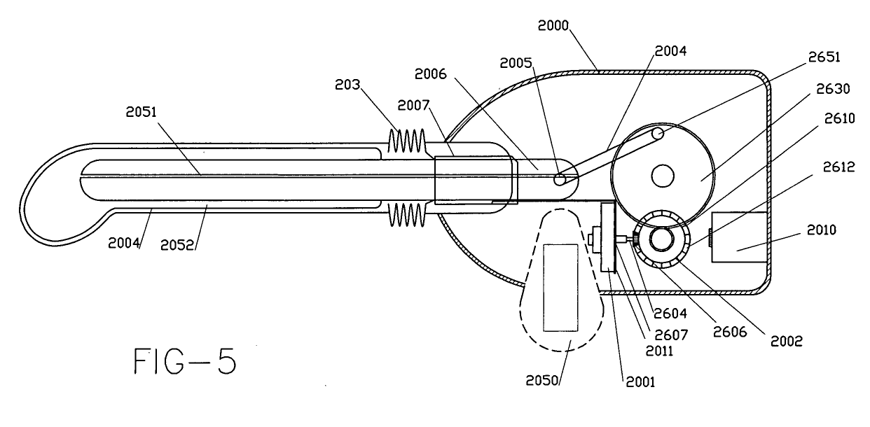

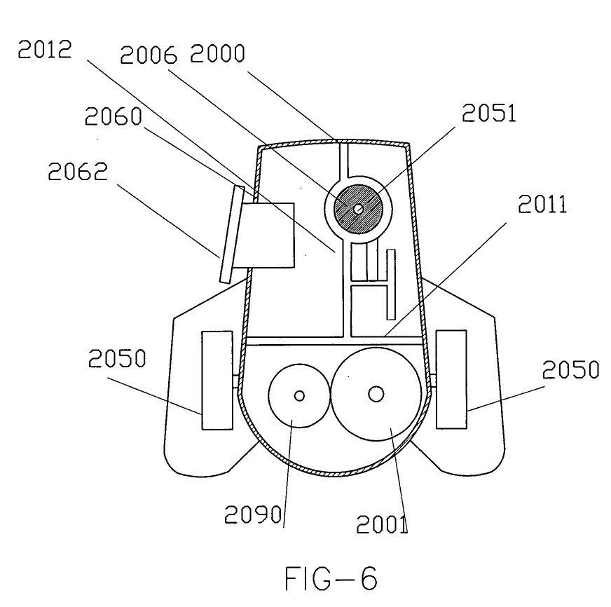

With reference to FIGS. 5 and 6, the said driven mechanism includes a motor 2001 may be powered by a battery (ies) 2010 or any other energy resource coupled to the motor 2001 through a switch (not shown), and a gearbox generally designated 2002 is installed on the supporting structures 2011, or any other forms of mechanism that generates linear reciprocating motions, is driven by the said motor. A functional arm 2006 that is attached to a rocker arm 2005 and 2004 and is housed by restraining tube 2007, which regulates horizontal reciprocating motion.

Still With reference to FIG. 5 and FIG. 6 to illustrate the structure of the power train and linear reciprocating motions, the motor 2001 is shown including a motor drive shaft 2604 for coupling the motor 2001 to a first bevel pinion gear 2606. drive shaft 2604 extends through wall 2011 through an aperture 2607. The first bevel pinion gear 2606 is coupled to a first driven bevel gear 2610 which in turn is coupled to a first spur gear 2612, a number of driven and spur gears installed on gear box supporting structure 2011 may be engaged in one after another as needed in order to reduce rotating speed and increase torque. A driven gear 2630 as last gear in the chain of gears is shown with a pin 2651 eccentrically installed. Pin 2651 is engageable to a reciprocator generally designated 2004, 2005, 2006, 2007 which will be described in further detail herein.

With continued reference to FIGS. 5 and 6, a rocker arm 2004 is shown bearingly connected one-end with the pin 2651 and the other end is bearingly connected with the functional arm 2006. The functional arm 2006 that is bearingly attached to a rocker arm 2005 and 2004 is housed by restraining tube 2007, which regulates horizontal reciprocating motion.

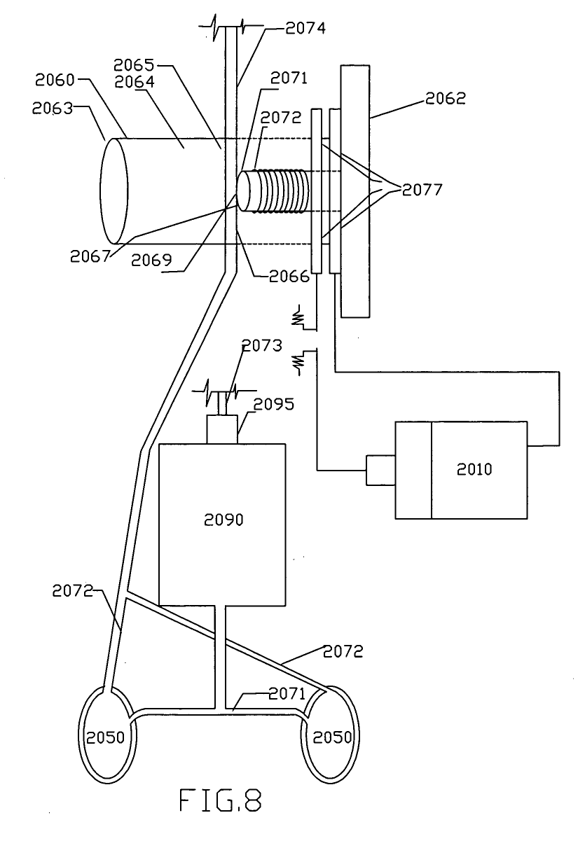

Still with reference to FIGS. 5, 6, and FIGS. 7, 8, a fluid pump 2090 is disposed in housing 201 and installed on supporting structure 2011. Two fluid containers 2050 located on each side of the housing 2000 are connected to the pump through ducts 2071. A heater 2095 may heat up the fluid approximately to body temperature or slightly higher is one-end connected from pump 2090 and the other-end connected to the outflow duct 2073. And the outflow duct 2073 is connected to the inflow connector 2080 located on functional arm 2006. Once pump 2090 is activated by pressuring switch panel 2062, the inflowing fluid will be ejected into the channel 2081 located within the functional arm 2006 through heater 2095 and further outflow duct 2073 and ejected into the designated sealed-surrounding compartment 2083, which is made of flexible materials such rubber or other flexible and expandable materials, from the functional arm 2006 through an open-end of the channel 2081 located within the center the functional arm 2006.

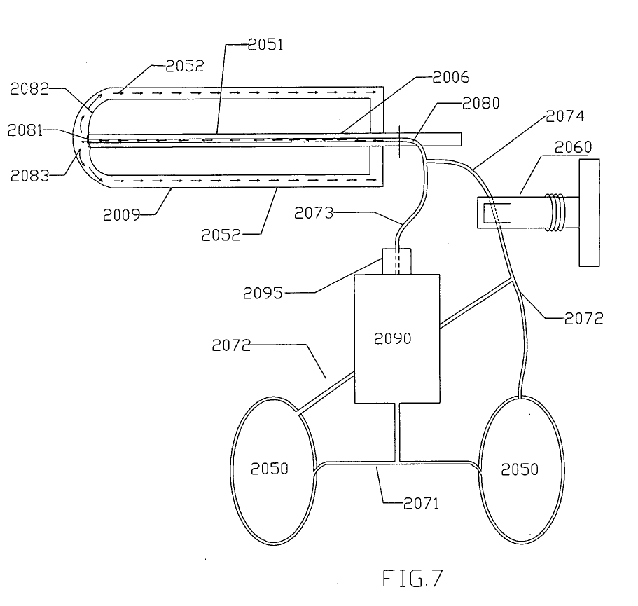

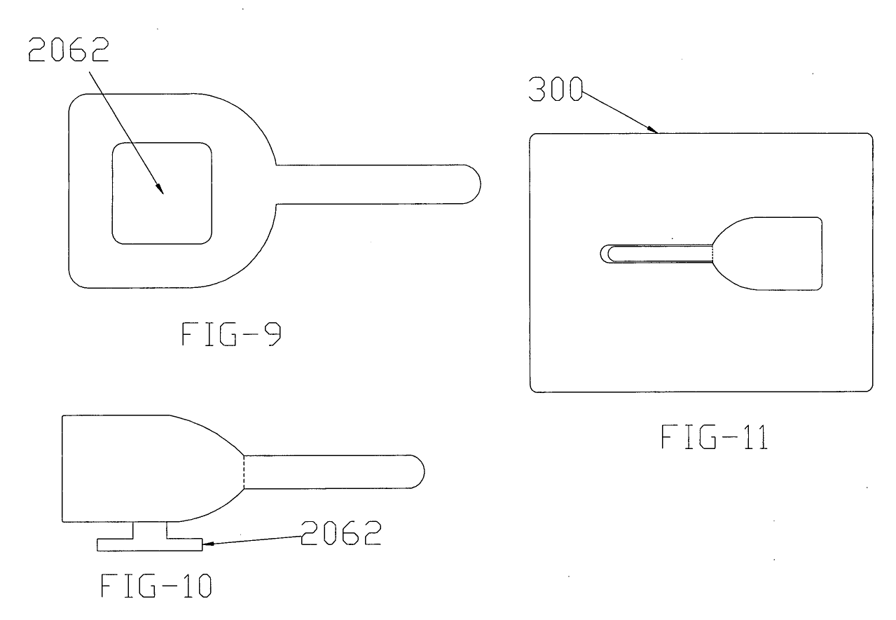

In reference to FIGS. 7, 8 and FIGS. 9, 10, backflow duct 2074 is connected to outflow duct 2073, the backflow duct 2074 is connected with a fluid-flow-control device 2063, and extended and connected to the containers 2050 via the fluid-flow-control device 2063. The fluid-flow-control device is consisted of a housing 2064 with inflow channel 2065 and outflow channel 2066 passing through the housing 2064, the backflow pass 2069 may be blocked by cylinder 2067. Cylinder 2067 is extended to panel 2062. With support of coil spring disposed around the extension part of cylinder 2066 the Panel 2062 is in upholding position. Small metal pieces 2077 acted as switch connectors are installed between the adjacent areas of housing 2064 and panel 2062 are wired to the batteries, By pressing down panel 2062 the switch connectors 2077 are connected and pump 2090 and heater 2095 are activated with power supply; cylinder 2067 prevents fluid from going back to the containers 2050 by blocking the backflow duct 2074 And therefore the designated sealed-surrounding compartment 2083 is enlarged by being ejected with fluid into the compartment, simulating penis reactions at male ejection stage; by releasing panel 2062, power supplies to the pump is cut off, and the backflow pass 2069 reopens and allows the fluid in compartment 2083 back to containers 2050 freely.

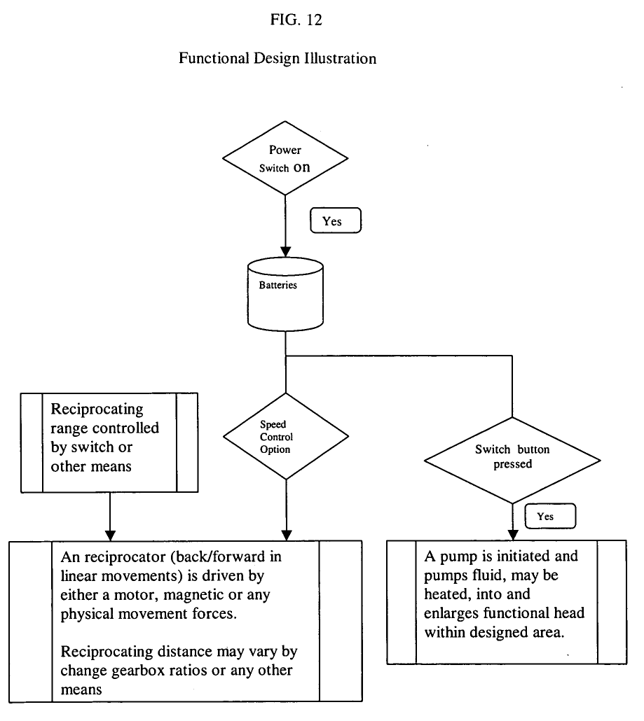

With reference to FIG. 12, functional logics are illustrated for the embodiment with wirings of the components and functional controls.

With reference to FIG. 2, functional arm 2006 (FIG. 5) is now covered with materials featured in the shape of penis 205; housing 2000 (FIG. 5) is now covered with materials featured in other structures of male genital 201; and the fluid containers 2050 (FIG. 5, 6) are now covered with materials in the shape of testicles 204.

Referring now to the drawings in detail, and particularly FIG. 11, a sexual intercourse simulator in FIG. 1, or FIG. 2 may be installed or attached to large base 300 such as stern pad, by a means of installation or attachment, as to prevent the said simulator from moving and to enable user to be hands-free as the user engages with the said simulator with its functions.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A male sexual intercourse simulator comprising:
a housing;
a drive mechanism disposed within the housing;
a reciprocator coupled to the drive mechanism;
a functional arm that creates linear back and forward reciprocating movements connected with the said reciprocator.
The said housing and the said functional arm may be covered with male genital features, including but not limited to penis, testicles, and or any other shapes that may cover the said housing and the said functional arm.

2. The male sexual intercourse simulator of claim 1, wherein the reciprocator is positioned within the housing to impart reciprocating linear motion to a functional arm.

3. The male sexual intercourse simulator of claim 2, wherein the reciprocating speed may be varied by a control mechanism.

4. The male sexual intercourse simulator of claim 2, wherein the travel distance of the reciprocator may be varied by a control mechanism.

5. The male sexual intercourse simulator of claim 1, wherein the said functional arm generates linear reciprocating motions that is covered with materials in male-penis shape, and or any designed shapes, materials and colors.

6. The male sexual intercourse simulator of claim 1, wherein the said housing may be covered with male genital features, including, but not limited to male genital body and testicles, and or it may also covered with any designed shapes, materials and colors.

7. A male sexual intercourse simulator comprising:
a housing;
a drive mechanism disposed within the housing;
a reciprocator coupled to the drive mechanism;
a functional arm that creates linear back and forward reciprocating movements connected with the said reciprocator;
a fluid or air pump that ejects fluid or air into the designated surrounding areas of the said functional arm when it is initiated;
a heating mechanism that heats up the temperatures of fluid or air close to human body's temperature or higher before the fluid or air ejected into the said functional arm by the said pump.
The said housing and the said functional arm may be covered with male genital features, including but not limited to penis, testicles, and or any other shapes that may cover the said housing and the said functional arm.

8. The male sexual intercourse simulator of claim 7, wherein the reciprocator is positioned within the housing to impart reciprocating linear motion to a functional arm.

9. The male sexual intercourse simulator of claim 8, wherein the reciprocating speed may be varied by a control mechanism.

10. The male sexual intercourse simulator of claim 8, wherein the travel distance of the reciprocator may be varied by a control mechanism.

11. The male sexual intercourse simulator of claim 7, wherein a fluid or air pump that ejects fluid or air into the designated surrounding areas of the said functional arm when it is initiated.

12. The male sexual intercourse simulator of claim 11, wherein a heating unit that heats up the temperatures of fluid or air close to human body's temperature or higher before the fluid or air ejected into the said functional arm by the said pump.

13. The male sexual intercourse simulator of claim 7, wherein the said functional arm generates linear reciprocating motions that is covered with materials in male-penis shape, and or any designed shapes, materials and colors.

14. The male sexual intercourse simulator of claim 7, wherein the said housing may be covered with male genital features, including, but not limited to male genital body and testicles, and or it may also covered with any designed shapes, materials and colors.

15. Male sexual intercourse simulators of claim 1 and claim 2 wherein, the said simulators may be installed on a stern base as to enable the users of the said simulators to be hands-free as they are engaged in activities with the said simulators.
